(19) United States
(12) Patent Application Publication
(10) Pub. No.: US 2005/0052538 A1
(43) Pub. Date: Mar. 10, 2005

(54) Camera and subject observing method

(76) Inventors: Tatsuya Sato, Iruma-shi (JP); Yuji Imai, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 10/938,982

(22) Filed: Sep. 10, 2004

(30) Foreign Application Priority Data
Sep. 10, 2003 (JP) 2003-318521

(51) Int. Cl. H04N 5/228

(52) U.S. Cl. 348/208.1

(57) ABSTRACT

In a camera for correcting camera shake by driving an image pickup device by driving a camera shake correction drive unit, when the camera shake correction drive unit is operated, in the case where a camera shake correction mode setting unit is set in a camera shake correction ON mode, a movable mirror is moved away from an optical path between an imaging optical system and an image pickup device, and the images from the image pickup device are repeatedly displayed on an image monitor.

### CROSS-REFERENCE TO RELATED APPLICATIONS

This application is based upon and claims the benefit of priority from prior Japanese Patent Application No. 2003-318521, filed Sep. 10, 2003, the entire contents of which are incorporated herein by reference.

### BACKGROUND OF THE INVENTION

1. Field of the Invention

The present invention relates to a camera having a camera shake correcting function.

2. Description of the Related Art

A camera having a camera shake correcting function for preventing effects of image movement on an imaging surface of an image pickup device due to camera shake when holding a camera, has been proposed in, for example, Jpn. Pat. Appln. KOKAI Publication No. 5-22649. The camera proposed in Jpn. Pat. Appln. KOKAI Publication No. 5-22649 is designed to detect a state of camera shake occurring when taking photographs, and the image pickup device is moved in a direction orthogonal to an optical axis of an imaging optical system depending on the detected state of camera shake, thereby correcting camera shake.

### BRIEF SUMMARY OF THE INVENTION

According to a first aspect of the present invention, there is provided a camera comprising:
an image pickup device which outputs image data by receiving incident luminous flux from an imaging optical system that receives luminous flux from a subject to be imaged;
an image monitor which displays an image on the basis of the image data outputted from the image pickup device;
an optical finder to observe the subject to be imaged;
a movable mirror disposed in an optical path between the imaging optical system and the image pickup device, the movable mirror guiding the luminous flux incoming from the imaging optical system to an optical finder side when observing the subject through the optical finder, and guiding the luminous flux incoming from the imaging optical system to an image pickup device side by moving away from the optical path when taking a photograph;
a camera shake correction unit which corrects camera shake by moving the image pickup device in a direction cross to the imaging optical axis of the imaging optical system;
a camera shake correction mode setting unit which sets the imaging mode of the camera in a camera shake correction mode of taking a photograph by operating the camera shake correction unit; and
an operation control unit which moves the movable mirror away from the optical path when the imaging mode is set in the camera shake correction mode by the camera shake correction mode setting unit, causes the image pickup device to output image data repeatedly, and displays the image on the image monitor on the basis of the repeatedly outputted image data.

According to a second aspect of the present invention, there is provided a camera comprising:
an image pickup device which outputs image data by receiving incident luminous flux from an imaging optical system that receives luminous flux from a subject to be imaged;
a camera shake correction unit which corrects camera shake by moving the image pickup device in a direction vertical to the imaging optical axis of the imaging optical system;
an image monitor comprising a first display mode for displaying an image on the basis of the image data outputted from the image pickup device when the camera shake correction unit is in action, and a second display mode for displaying an image on the basis of the image data outputted from the image pickup device when the camera shake correction unit is not in action;
a camera shake correction mode setting unit which sets the imaging mode of the camera in a camera shake correction mode of taking a photograph by operating the camera shake correction unit; and
an operation control unit which controls to change over the display modes of the image monitor depending on the setting state of the camera shake correction mode setting unit.

According to a third aspect of the present invention, there is provided a camera comprising:
an image pickup device which outputs image data by receiving incident luminous flux from an imaging optical system that receives luminous flux from a subject to be imaged;
an image monitor which displays an image on the basis of the image data outputted from the image pickup device;
an optical finder to observe the subject to be imaged;
a movable mirror disposed in an optical path between the imaging optical system and the image pickup device, the movable mirror guiding the luminous flux incoming from the imaging optical system to an optical finder side when observing the subject through the optical finder, and guiding the luminous flux incoming from the imaging optical system to an image pickup device side by moving away from the optical path when taking a photograph;
a camera shake correction unit which corrects camera shake by moving the image pickup device in a direction cross to the imaging optical axis of the imaging optical system;
a camera shake correction mode setting unit which sets the imaging mode of the camera in a camera shake correction mode of taking a photograph by operating the camera shake correction unit; and
an operation control unit which operates by changing over between a first observation mode and a second observation mode, the first observation mode enabling observation of the subject through the optical finder by disposing the movable mirror on the optical path when the imaging mode is set in the camera shake correction mode by the camera shake correction mode setting unit, and the second observation mode enabling observation of the subject by displaying the image data from the image pickup device on the image monitor by moving the movable mirror away from the optical path when the imaging mode is set in the camera shake correction mode by the camera shake correction mode setting unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing an internal configuration of a camera according to a first embodiment of the present invention;

FIG. 2 is a diagram of the internal configuration of the camera according the first embodiment of the invention as seen from the side of the camera;

FIG. 3 is an outline rear view of the camera according to the first embodiment of the invention;

FIG. 4 is a diagram of a display example in the case of viewing an optical finder during operation of a camera shake correcting function;

FIG. 5 is a flowchart showing imaging control in the camera according to the first embodiment of the invention;

FIG. 6 is a flowchart showing 1R pretreatment in the first embodiment of the invention;

FIG. 7 is a flowchart of camera shake correction start process in the first embodiment;

FIG. 8 is a flowchart of camera shake correction end process in the first embodiment;

FIG. 9 is an outline rear view of a camera according to a second embodiment of the present invention;

FIG. 10 is a flowchart showing 1R pretreatment in the second embodiment;

FIG. 11 is a flowchart showing camera shake correction mode change process in the second embodiment;

FIG. 12 is an outline rear view of a camera according to a third embodiment of the present invention;

FIG. 13 is a flowchart showing 1R pretreatment in the third embodiment;

FIG. 14 is a flowchart showing camera shake correction end process 1 in the third embodiment;

FIG. 15 is a flowchart showing camera shake correction start process 1 in the third embodiment; and

FIGS. 16 and 17 are flowcharts showing exposure process in the third embodiment.

### DETAILED DESCRIPTION OF THE INVENTION

Embodiments of the present invention will be specifically described below while referring to the accompanying drawings.

[First Embodiment]

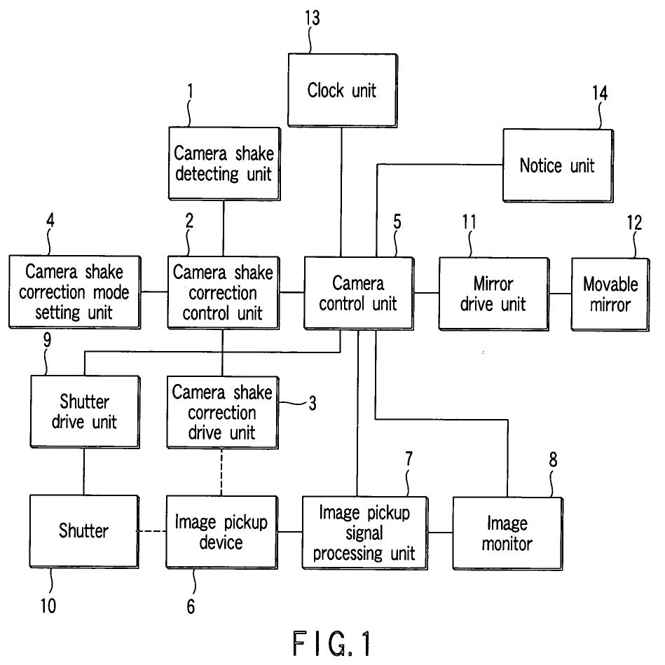

FIG. 1 is a block diagram showing a configuration of a camera according to a first embodiment of the present invention. The camera comprises a camera shake detecting unit 1, a camera shake correction control unit 2, a camera shake correction drive unit 3, a camera shake correction mode setting unit 4, a camera control unit 5, an image pickup device 6, an image pickup signal processing unit 7, an image monitor 8, a shutter drive unit 9, a shutter 10, a mirror drive unit 11, a movable mirror 12, a clock unit 13, and a notice unit 14.

The camera shake detecting unit 1 is composed of, for example, a vibration detection sensor such as an angular velocity sensor, and the magnitude of camera shake is detected by sensing the vibration of the camera. In FIG. 1, only one camera shake detecting unit 1 is shown, but actually this camera has two vibration detection sensors in order to detect camera shake in two axial directions vertical to an optical axis of an imaging optical system (not shown). The magnitude of camera shake detected by the camera shake detecting unit 1 is outputted to the camera shake correction control unit 2. The camera shake correction control unit 2 drives the camera shake correction drive unit 3 as the camera shake correction unit depending on the magnitude of camera shake. The camera shake correction drive unit 3 is a drive mechanism (actuator) for driving the image pickup device 6.

The camera shake correction mode setting unit 4 is a switch member for manually setting the camera shake correction mode of the camera. The camera shake correction mode will be described below.

The camera control unit 5 as the operation control unit is composed of microcomputer or the like, and is responsible for control of the entire camera including the camera shake correction control.

The image pickup device 6 is composed of, for example, a CCD, and receives a luminous flux from a subject (not shown) to convert this luminous flux into an electric signal (image pickup signal). The camera shake correction drive unit 3 drives the image pickup device 6 depending on the camera shake occurring in this camera. As a result, a luminous flux entering in a certain pixel on the image pickup device 6 will not get into another pixel due to occurrence of camera shake.

The output from the image pickup device 6 is put into the image pickup signal processing unit 7. The image pickup signal processing unit 7 digitizes the input signal, and applies known image processing to generate image data. On the basis of this image data, an image is displayed on the image monitor 8. The shutter drive unit 9 is a driving mechanism for opening and closing the shutter (focal plane shutter) 10. The shutter 10 is a shielding member for controlling the quantity of exposure light of the image pickup device 6. The mirror drive unit 11 is a driving mechanism for driving the movable mirror 12 for reflecting or transmitting the luminous flux from the subject (not shown).

Display control of the image monitor 8, driving control of the shutter 10, driving control of the movable mirror 12, and the like are all executed by the camera control unit 5.

The clock unit 13 is a timer for measuring the time. The clock unit 13 may be built in the camera control unit 5. The notice unit 14 is a member for notifying the user of a camera shake correction mode by lighting an LED or the like.

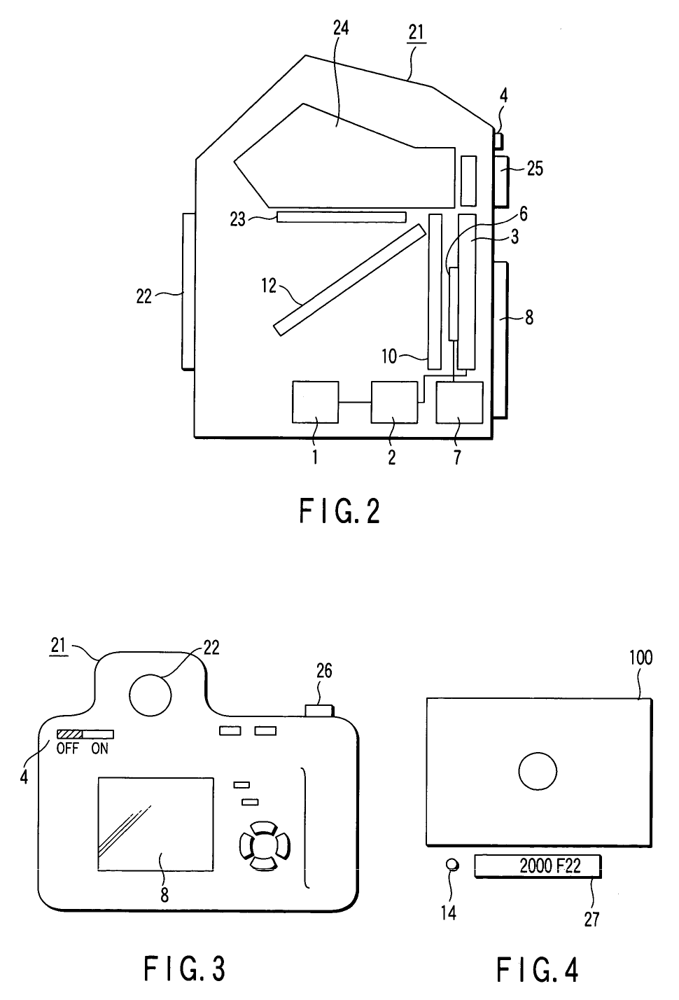

FIG. 2 is a left side view of the internal structure of the camera according to the first embodiment of the invention. The camera in FIG. 2 is a single-lens reflex camera of lens exchange type. That is, a camera body 21 is configured to mount an imaging lens (not shown) by way of a mount portion 22. The imaging lens incorporates an optical system (imaging optical system) composed of plural lenses in the inside, and a luminous flux from the subject (not shown) enters the camera body 21.

FIG. 2 shows a state of the movable mirror 12 positioned in the optical path between the imaging optical system (not shown) and the image pickup device 6. In this state, the luminous flux from the subject (not shown) is reflected in the upward direction in the drawing by the movable mirror 12. The luminous flux reflected by the movable mirror 12 is sent into a finder optical system (optical finder) composed of a screen mat 23, a pentaprism 24, and a finder eyepiece 25. That is, the luminous flux entering the finder optical system first focuses an image on the screen mat 23. The pentaprism 24 inverts the direction of the image focused on the screen mat 23, and further puts into the finder eyepiece 25. As a result, the user can observe the subject to be imaged by way of the finder eyepiece 25.

On the other hand, when taking a photograph, the movable mirror 12 retreats from the optical path between the imaging optical system (not shown) and the image pickup device 6, and the luminous flux entering through the imaging optical system gets into the image pickup device 6 side.

FIG. 3 is an outline rear view of the camera in FIG. 2. In the first embodiment, by turning on or off the camera shake correction mode setting unit 4 exposed and disposed on the rear side of the camera body 21, it can be set whether or not to operate the camera shake correction drive unit 3 at the time of taking a photograph. Or by pressing a release button 26, a release switch (not shown) in the camera is turned on, and a series of imaging sequence explained below is executed. The release switch is composed of two switches, a first release switch (hereinafter referred to as 1R switch) and a second release switch (thereinafter referred to as 2R switch). That is, when the 1R switch is turned on, AE and AF are executed as preparatory motion of exposure, and when the 2R switch is turned on, the exposure is executed.

In the camera having the configuration as shown in FIG. 2, the effect of the camera shake correction function cannot be confirmed by the optical finder. Accordingly, in the first embodiment, the image monitor 8 is used as the finder during operation of the camera shake correction function. At this time, the state in which the optical finder is seen from the finder eyepiece is shown in FIG. 4. Herein, the aperture value and shutter speed may be displayed in a position indicated by reference numeral 27 in the lower part of an imaging screen frame 100. Further, during operation of the camera shake correction function, it is noticed to the user by lighting the LED or the like as the notice unit 14. In this informing mode by the notice unit 14, the lighting status of the LED may be changed depending on the magnitude of camera shake detected by the camera shake detecting unit 1. For example, by flickering the LED when the magnitude of camera shake is large, the user can easily recognize that the current occurrence of camera shake is very large. In the first embodiment, the LED is used as the notice unit 14, but it is not limited to this example alone.

What is shown in the center of the imaging screen frame 100 is an AE area. The AE area is also an AF area.

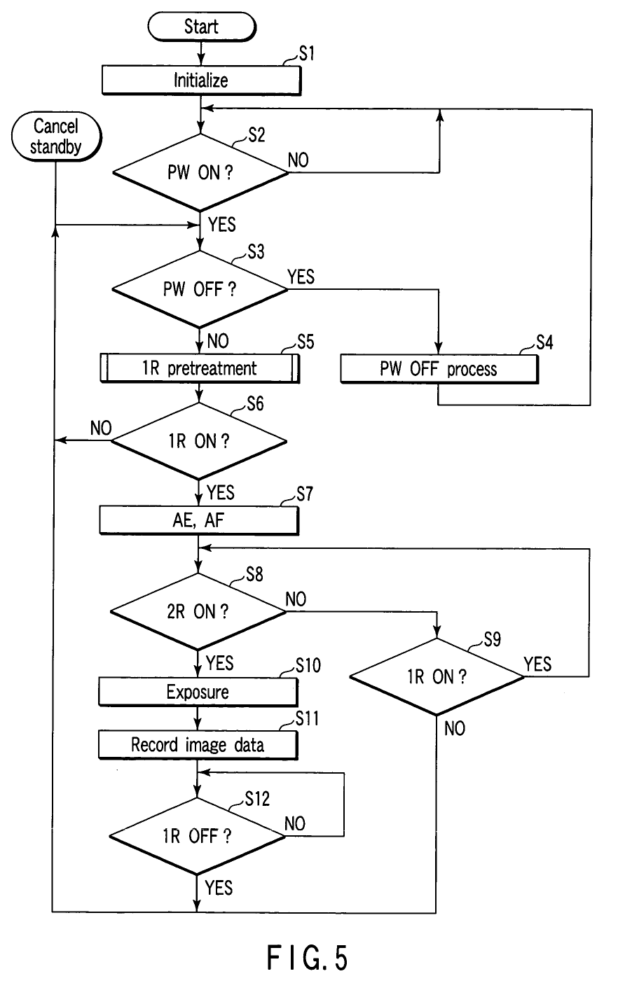

Imaging control of the camera having such a configuration will be explained by referring to FIG. 5. This flowchart is executed by the camera control unit 5, for example, when the camera is loaded with a battery. In FIG. 5, first, the camera control unit 5 initializes the setting values of a register (not shown) (step S1). It is determined whether or not the power switch (PW switch) is turned on (step S2), and it is designed to wait until the PW switch is determined to be turned on.

When the PW switch is determined to be turned on in step S2, the camera control unit 5 determines whether the PW switch is turned off or not (step S3). In step S3, when the PW switch is determined to be turned off, the display of the image monitor is turned off, and the camera power source is turned off (step S4). On the other hand, in step S3, when the PW switch is determined to be turned on, 1R pretreatment is executed (step S5). This 1R pretreatment will be explained later.

After 1R pretreatment, the camera control unit 5 determines whether the 1R switch is turned on or not (step S6). In step S6, when the 1R switch is determined to be turned off, the process returns to step S3. When the 1R switch is determined to be turned on, on the other hand, the AE and AF are executed (step S7). When the movable mirror 12 is positioned in the optical path between the imaging optical system (not shown) and the image pickup device 6 (the camera shake correction drive unit 3 is not in action), the AE and AF on the basis of the output of the image pickup device 6 cannot be executed, and hence the AE and AF are executed by using an AE sensor and an AF sensor, which are not shown, in the camera. On the other hand, when the movable mirror 12 is away from the optical path between the imaging optical system (not shown) and the image pickup device 6 (the camera shake correction drive unit 3 is in action), the AE and AF are executed on the basis of the output of the image pickup device 6. These techniques are known arts, and detailed description is omitted.

After AE and AF process, the camera control unit 5 determines whether the 2R switch is turned on or not (step S8). In step S8, when the 2R switch is determined to be turned off, the camera control unit 4 determines again whether the 1R switch is turned on or not (step S9). In step S9, when the 1R switch is determined to be turned on, the process returns to step S8. On the other hand, in step S9, when the 1R switch is determined to be turned off, the process returns to step S3.

In step S8, when the 2R switch is determined to be turned on, the camera control unit 5 executes exposure control (step S10). Then, the acquired image data is recorded in a recording medium such as, for example, a memory card (step S11). After recording the image, the camera control unit 5 determines whether the 1R switch is turned off or not (step S12), and it is designed to wait until the 1R switch is turned off. On the other hand, when the 1R switch is determined to be turned off, the process returns to step S3.

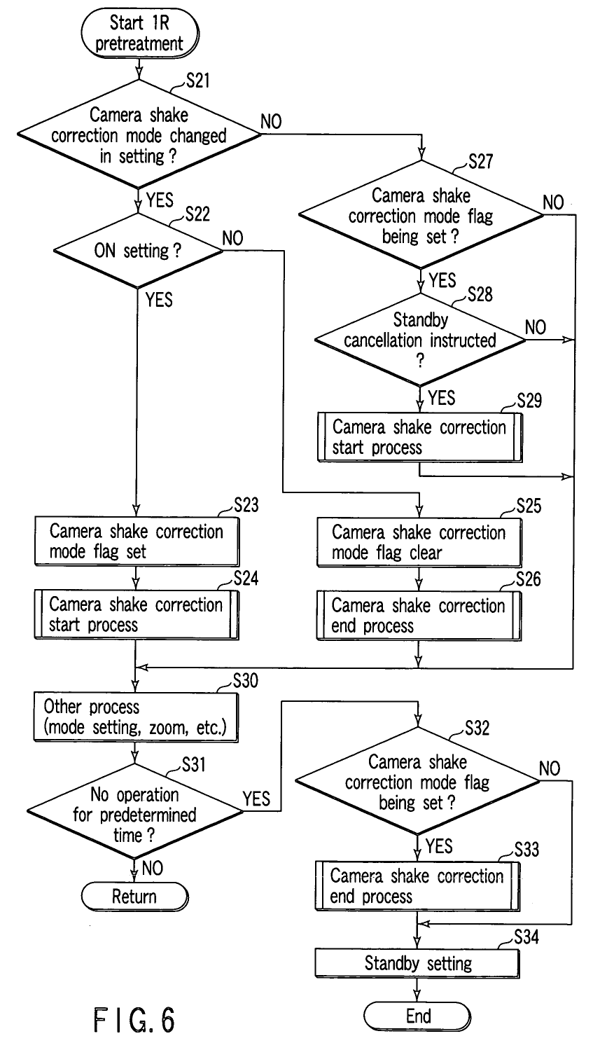

Herein, the 1R pretreatment in step S5 is specifically described by referring to FIG. 6. In 1R pretreatment in FIG. 6, the camera control unit 5 determines whether the camera shake correction mode setting has been changed or not, that is, the state of the camera shake mode setting unit 4 in FIG. 3 has been changed or not (step S21). In step S21, if it is determined that setting of camera shake correction mode has been changed, the camera control unit 5 determines whether the camera shake correction mode setting unit 4 is turned on or not (step S22). In step S22, when the camera shake correction mode setting unit 4 is determined to be turned on, the camera control unit 5 sets a camera shake correction mode flag (step S23), and starts camera shake correction (step S24). In step S22, if the camera shake correction mode setting unit 4 is determined to be turned off, the camera control unit 5 clears the camera shake correction mode flag (step S25), and terminates camera shake correction process (step S26). The camera shake correction start process and camera shake correction end process will be described later.

In step S21, when it is determined that the setting of camera shake correction mode has not been changed, the camera control unit 5 determines whether the camera shake correction mode flag is being set or not (step S27). In step S27, when it is determined that the camera shake correction mode flag is being set, the camera control unit 5 determines whether cancellation of the standby mode has been instructed by the user or not (step S28). In step S28, when it is determined that cancellation of the standby mode has been instructed, the camera control unit 5 starts camera shake correction (step S29). On the other hand, in step S27, if it is determined that the camera shake correction mode flag is not set or that cancellation of the standby mode is not instructed, the process goes to step S30 without starting camera shake correction.

After process about camera shake correction is terminated in this manner, the camera control unit 5 executes other process than camera shake correction, such as process about camera imaging mode setting or zoom setting (step S30). Next, the camera control unit 5 determines whether the state in which the camera is not in action continues for a predetermined time or not (step S31). This predetermined time is measured by the clock unit 13.

In step S31, if it is determined that the predetermined time has not passed yet, going out of the flowchart in FIG. 6, the process moves to step S6 in FIG. 5. On the other hand, in step S31, if it is determined that the predetermined time has passed, the camera control unit 5 determines whether the camera shake correction mode flag is being set or not (step S32). In step S32, if it is determined that the camera shake correction mode flag is being set, the camera control unit 5 terminates the camera shake correction (step S33), and sets the camera in the standby mode (power saving mode) (step S34). The standby mode is a mode of turning off the camera function such as image display in order to save power consumption while the camera is not handled by the user. During the standby mode, if the user manipulates the camera, the standby mode is canceled, and the camera control unit 5 starts control from step S3 in FIG. 5.

On the other hand, in step S32, if it is determined that the camera shake correction mode flag is not being set, the process goes to step S34 without terminating camera shake correction, and the camera is set in the standby mode.

Camera shake correction start process in step S24 and camera shake correction end process in step S26 will be explained below.

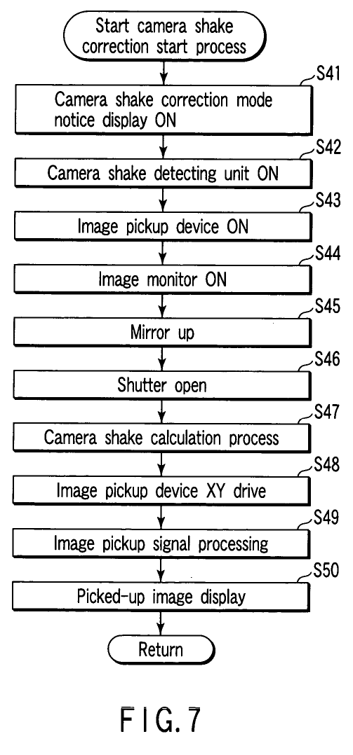

First, the camera shake correction start process is explained by referring to FIG. 7. In the camera shake correction start process, in order to inform the user that the camera shake correction mode is turned on, the LED display of the notice unit 14 is turned on (step S41). Next, the camera control unit 5 starts operation of the camera shake detecting unit 1 by way of the camera shake correction control unit 2 (step S42). Then, the image pickup device 6 is turned on (step S43), and the image monitor 8 is turned on (step S44).

To make the incident luminous flux from the imaging optical system enter the image pickup device 6, the movable mirror 12 is moved up away from the optical path between the imaging optical system (not shown) and the image pickup device 6 (step S45), and the shutter 10 is opened (step S46). Thereafter, on the basis of result of detection by the camera shake detecting unit 1, the magnitude of camera shake and direction of camera shake are calculated (step S47), and the camera shake correction drive unit 3 is driven according to the result of operation to drive the image pickup device 6 (step S48).

The camera control unit 5 processes the image of the output of the image pickup device 6 in the image pickup signal processing unit 7 (step S49), and the result is displayed on the image monitor 8 (step S50). Herein, the operation of step S47 to step S50 is carried out continuously until the end of the camera shake correction mode. By operating the image pickup device 6 repeated in this manner, the user can observe the image data in the state in which the camera shake correction function is in action in real time.

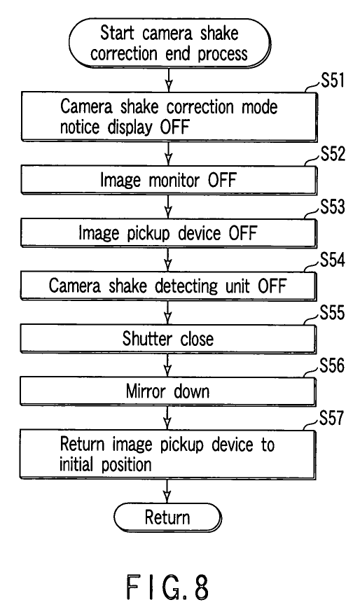

Now, the camera shake correction end process is explained by referring to FIG. 8. In the camera shake correction end process, the camera control unit 5 turns off the LED display of the notice unit 14 (step S51). Next, the image monitor 8 is turned off (step S52). Further, the image pickup device 6 is turned off (step S53). Then, the camera control unit 5 stops the operation of the camera shake detecting unit 1 by way of the camera shake correction control unit 2 (step S54).

Consequently, the camera control unit 5 closes the shutter 10 (step S55), and moves down the movable mirror 12 to be positioned in the optical path between the imaging optical system (not shown) and the image pickup device 6 (step S56). Further, the image pickup device 6 is returned to the initial position, for example, a position at which the center of the image pickup device is coincided with the imaging optical axis of the imaging optical system (step S57).

As explained herein, according to the first embodiment, when the camera shake correction mode is turned on, the image is displayed on the image monitor, instead of the optical finder, so that the user can recognize the effect of the camera shake correction function before taking a photograph. In addition, since the camera shake correction mode is indicated by display by the notice unit, the user can easily recognize whether the camera shake correction function is active or not. Still more, when the camera comes into the standby mode, the image monitor and camera shake correction drive unit area set in the inactive state, so that the power consumption can be saved.

[Second Embodiment]

A second embodiment of the present invention will be described below. In the second embodiment, the display mode of the image monitor has two modes, first display mode and second display mode, and these display modes can be changed over depending on the state of the camera shake correction mode setting unit.

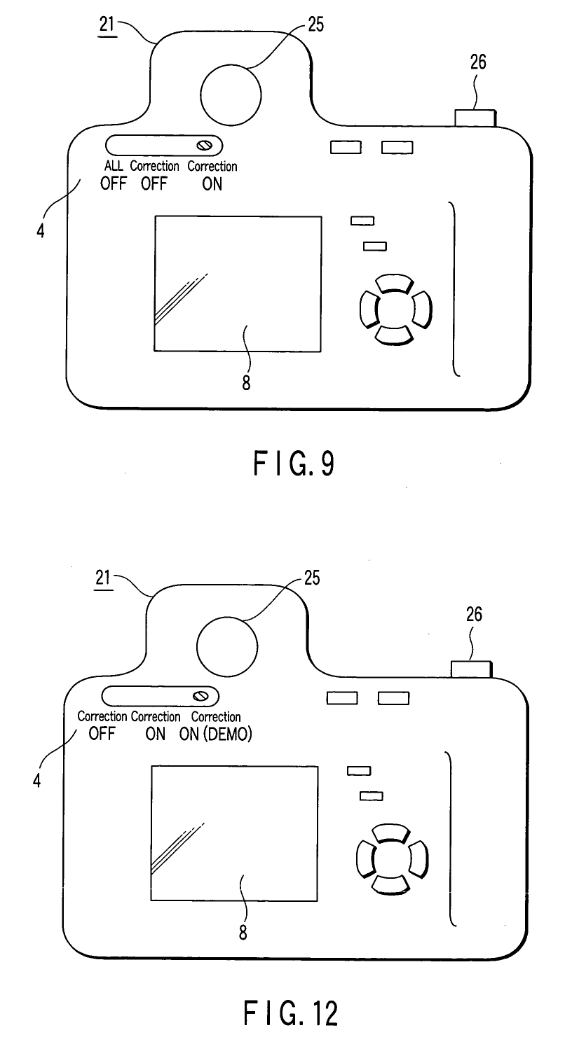

FIG. 9 is an outline rear view of a camera according to the second embodiment. As shown in FIG. 9, the second embodiment has three modes, that is, a camera shake correction ON mode (first display mode) for displaying the image in the state in which the camera shake correction drive unit 3 is active; a camera shake correction OFF mode (second display mode) for displaying the image in the state in which the camera shake correction drive unit 3 is inactive; and an ALL OFF mode for turning off both the camera shake correction drive unit 3 and image monitor 8. The other configuration and imaging control are same as in the first embodiment, and the explanation is omitted.

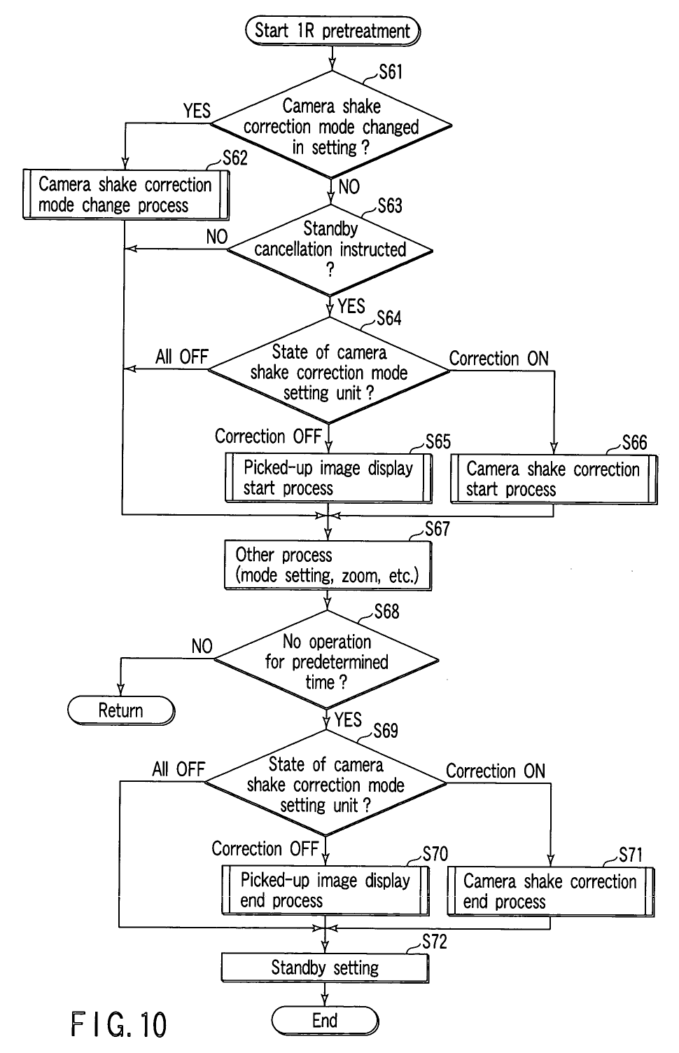

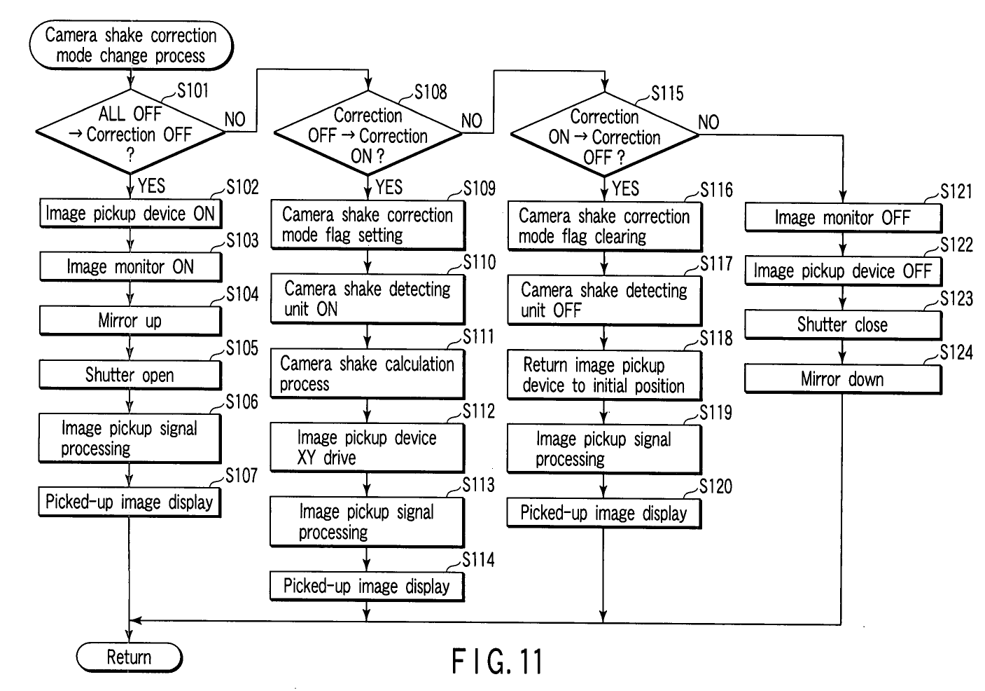

FIG. 10 is a flowchart showing control procedure of 1R pretreatment in the second embodiment. In the 1R pretreatment in FIG. 10, the camera control unit 5 determines whether the camera shake correction mode setting has been changed or not (step S61). In step S61, if it is determined that setting of the camera shake correction mode has been changed, the camera control unit 5 executes the camera shake correction mode change process (step S62).

In step S61, on the other hand, when it is determined that the setting of the camera shake correction mode has not been changed, the camera control unit 5 determines whether cancellation of the standby mode has been instructed by the user or not (step S63). In step S63, when it is determined that cancellation of the standby mode has been instructed, the camera control unit 5 determines the state of the camera shake correction mode setting unit 4 (step S64).

In step S64, when it is determined that the camera shake correction mode setting unit 4 is set in the ALL OFF mode, the process moves to step S67. When the camera shake correction mode setting unit 4 is set in correction OFF mode, the taken image display start process is executed (step S65), and the process goes to step S67. Herein, the taken image display start process is the process other than the process concerning the camera shake correction function in the camera shake correction start process in FIG. 7, that is, the process for executing step S43, step S44, step S45, step S46, step S49 and step S50. Further, when the camera shake correction mode setting unit 4 is set in the correction ON mode, the process same as the camera shake correction start process as in FIG. 7 is executed (step S66), and the process goes to step S67.

In this way, after the process concerning the camera shake correction is over, the camera control unit 5 executes the process other than camera shake correction, such as processing concerning camera imaging mode setting or zoom setting (step S67). Consequently, the camera control unit 5 determines whether the state in which the camera is in active continues for a predetermined time or not (step S68). In step S68, if not passing the predetermined time, the process goes to step S6 in FIG. 5, going out of the flowchart in FIG. 10. On the other hand, in step S68, when determined to have passed the predetermined time, the camera control unit 5 determines the state of the camera shake correction mode setting unit 4 (step S69).

In step S69, when it is determined that the camera shake correction mode setting unit 4 is set in the ALL OFF mode, the process goes to step S72. When the camera shake correction mode setting unit 4 is set in the correction OFF mode, the taken image end process is executed (step S70), and the process goes to step S72. The taken image display end process is the process other than the process concerning the camera shake correction function in the camera shake correction end process in FIG. 8, that is, the process for executing step S52, step S53, step S55 and step S56. Further, when the camera shake correction mode setting unit 4 is set in the correction ON mode, processing same as in the camera shake correction process in FIG. 8 is executed (step 71), the process goes to step S72. After these processes corresponding to the state of the camera shake correction mode setting unit 4, the camera is set in the standby mode (step S72).

Referring to FIG. 11, the camera shake correction mode setting process in step S62 in FIG. 10 will be explained below. In the process in FIG. 11, it is determined how the state of the camera shake correction mode setting unit 4 is changed, and the process corresponding to the determination result is executed.

In FIG. 11, the camera control unit 5 first determines whether or not the state of the camera shake correction mode setting unit 4 has been changed from the ALL OFF mode to the correction OFF mode (step S101). In step S101, when it is determined that the state of the camera shake correction mode setting unit 4 has been changed from the ALL OFF mode to the correction OFF mode, only the process concerning image display is executed. That is, the camera control unit 5 turns on the image pickup device 6 (step S102), and the image monitor 8 is turned on (step S103). Then the movable mirror 12 is moved up (step S104), and the shutter 10 is opened (step S105). Next, the camera control unit 5 processes the image of the output of the image pickup device 6 in the image pickup signal processing unit 7 (step S106), and the result is displayed on the image monitor 8 (step S107).

In step S101, when it is determined that the state of the camera shake correction mode setting unit 4 is not changed from the ALL OFF mode to the correction OFF mode, the camera control unit 5 determines whether or not the state of the camera shake correction mode setting unit 4 has been changed from the correction OFF mode to the correction ON mode (step S108). In step S108, when it is determined that the state of the camera shake correction mode setting unit 4 has been changed from the correction OFF mode to the correction ON mode, since the image is already displayed, only the process of camera shake correction is executed. That is, the camera control unit 5 sets the camera shake correction flag (step S109), and turns on the camera shake detecting unit 1 by way of the camera shake correction control unit 2 (step S110). In succession, by camera shake calculation (step S111), the image pickup device 6 is driven according to the result of calculation (step S112). Then, the camera control unit 5 processes the image of the output of the image pickup device 6 in the image pickup signal processing unit 7 (step S113), and the result is displayed on the image monitor 8 (step S114).

In step S108, when it is determined that the state of the camera shake correction mode setting unit 4 is not changed from the correction OFF mode to the correction ON mode, the camera control unit 5 determines whether or not the state of the camera shake correction mode setting unit 4 has been changed from the correction ON mode to the correction OFF mode (step S115). In step S115, when it is determined that the state of the camera shake correction mode setting unit 4 has been changed from the correction ON mode to the correction OFF mode, only the process of terminating the camera shake correction function is executed. That is, the camera control unit 5 clears the camera shake correction flag (step S116), and turns off the camera shake detecting unit 1 by way of the camera shake correction control unit 2 (step S117). In succession, the camera control unit 5 returns the image pickup device 6 to the initial position (step S118). Thereafter, the camera control unit 5 processes the image of the output of the image pickup device 6 in the image pickup signal processing unit 7 (step S119), and the result is displayed on the image monitor 8 (step S120).

In step S115, when it is determined that the state of the camera shake correction mode setting unit 4 is not changed from the correction ON mode to the correction OFF mode, it is the case where the state of the camera shake correction mode setting unit 4 has been changed from the correction OFF mode to the ALL OFF mode. In this case, the camera control unit 5 turns off the image monitor 8 (step S121), and further turns off the image pickup device 6 (step S122). Then, closing the shutter 10 (step S123), the movable mirror 12 is moved down (step S124).

In this case, if the state of the camera shake correction mode setting unit 4 is changed consecutively in two steps, for example, from the ALL OFF mode to the correction ON mode, the determination in FIG. 11 is executed two times. That is, in the second embodiment, even if another process is being executed, when the state of the camera shake correction mode setting unit 4 has been changed, determination in step S101 is started immediately by the interrupt process.

As described herein, according to the second embodiment, the image can be displayed without operation of the camera shake correction drive unit.

[Third Embodiment]

A third embodiment of the present invention will be described below. FIG. 12 is an outline rear view of a camera according to the third embodiment. As shown in FIG. 12, the camera shake correction mode setting unit 4 of the third embodiment has a camera shake correction ON mode capable of observing the subject by the optical finder in the state in which the camera shake correction drive unit 3 is in action, in addition to the camera shake correction ON mode (DEMO) corresponding to the camera shake correction ON mode in the second embodiment and camera shake OFF mode corresponding to the ALL OFF mode in the second embodiment. The other configuration is same as in the first and second embodiments, and the explanation is omitted.

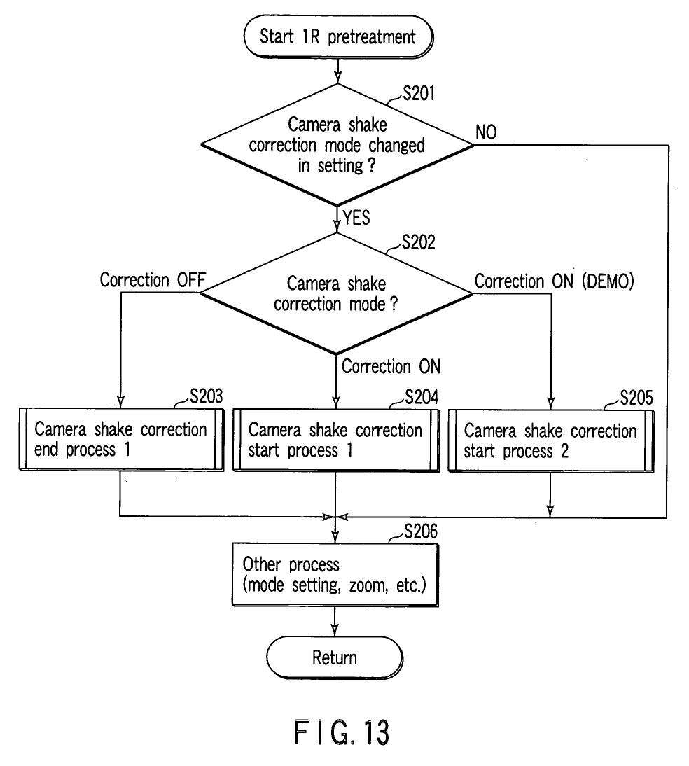

Only the different points from the first and second embodiments are explained below. FIG. 13 is a flowchart showing control procedure of 1R pretreatment in the third embodiment. In the 1R pretreatment in FIG. 13, the camera control unit 5 determines whether the camera shake correction mode setting has been changed or not (step S201). In step S201, if it is determined that setting of the camera shake correction mode has not been changed, the process goes to step S206.

In step S201, on the other hand, if it is determined that setting of the camera shake correction mode has been changed, the camera control unit 5 determines the camera shake correction mode setting unit 4 has been changed to which mode (step S202).

In step S201, if it is determined that setting of the camera shake correction mode has been changed to the correction OFF mode, camera shake correction end process 1 is executed (step S203). This camera shake correction end process 1 will be explained later. After the process in step S203, the process goes to step S206.

In step S201, if it is determined that setting of the camera shake correction mode has been changed to the correction ON mode, camera shake correction start process 1 is executed (step S204). This camera shake correction start process 1 will be explained later. After the process in step S204, the process goes to step S206.

In step S201, if it is determined that setting of the camera shake correction mode has been changed to the correction ON (DEMO) mode, camera shake correction start process 2 is executed (step S205). This camera shake correction start process 2 is same process as the camera shake correction start process in FIG. 7. After step S205, the process goes to step S206.

In this way, after the process about camera shake correction is over, the camera control unit 5 executes the process other than camera shake correction, such as processing concerning camera imaging mode setting or zoom setting (step S206).

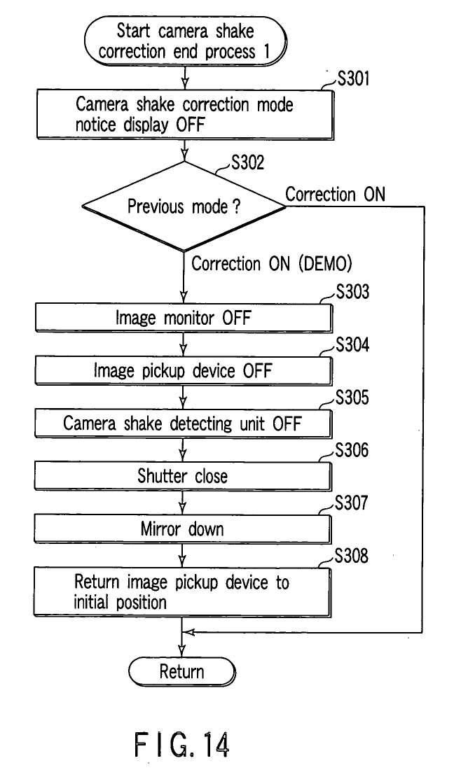

FIG. 14 is a flowchart showing process of the camera shake correction end process 1 in step S203 in FIG. 13. That is, in the camera shake correction end process 1 in FIG. 14, the camera control unit 5 turns off the LED display of the notice unit 14 (step S301). Then the camera control unit 5 determines the previous camera shake correction mode (step S302). In step S302, if the previous camera shake correction mode is the correction ON mode, the process goes out of the flowchart in FIG. 14.

In step S302, on the other hand, if the previous camera shake correction mode is the correction ON (DEMO) mode, the camera control unit 5 turns off the image monitor 8 (step S303). Hereinafter, the process in step S304 to step S308 is same as the process in step S53 to step S57 in the camera shake correction end process in FIG. 8, and the explanation is omitted.

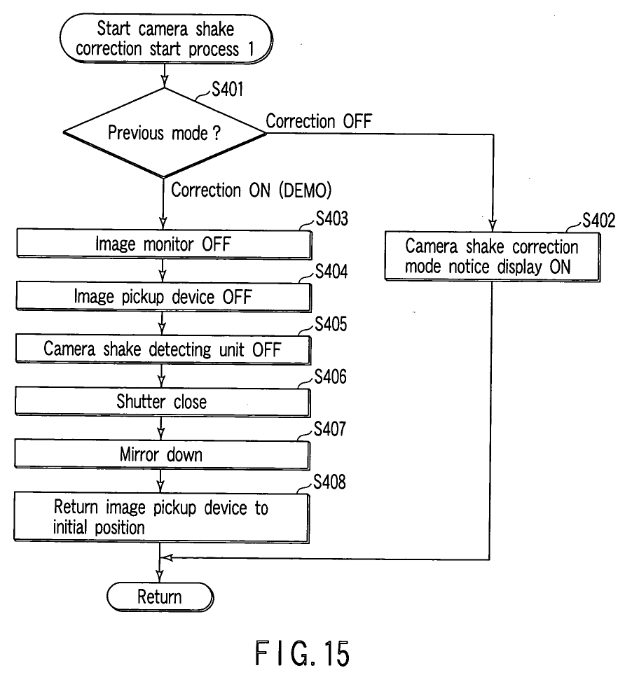

FIG. 15 is a flowchart showing process of the camera shake correction start process 1 in step S204 in FIG. 13. That is, in the camera shake correction start process 1 in FIG. 15, the camera control unit 5 determines the previous camera shake correction mode (step S401). In step S401, if the previous camera shake correction mode is the correction OFF mode, the camera control unit 5 turns on the LED display of the notice unit 14 (step S402), and the process goes out of the flowchart in FIG. 15.

On the other hand, in step S401, if the previous camera shake correction mode is the correction ON (DEMO) mode, the camera control unit 5 turns off the image monitor 8 (step S403). Hereinafter, the process in step S404 to step S408 is same as the process in step S53 to step S57 in the camera shake correction end process in FIG. 8, and the explanation is omitted.

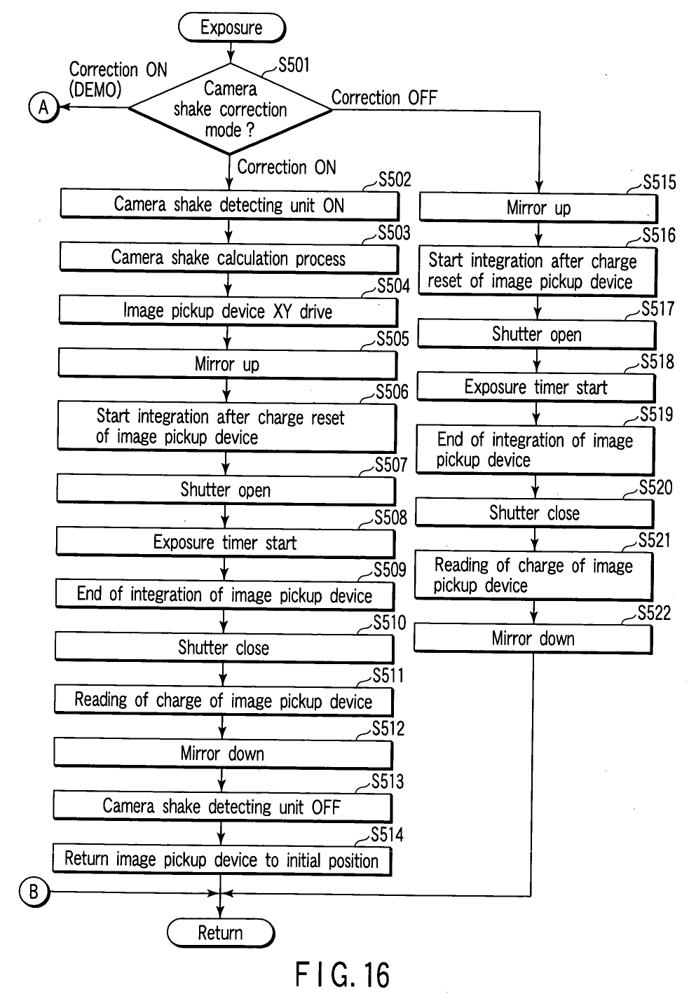

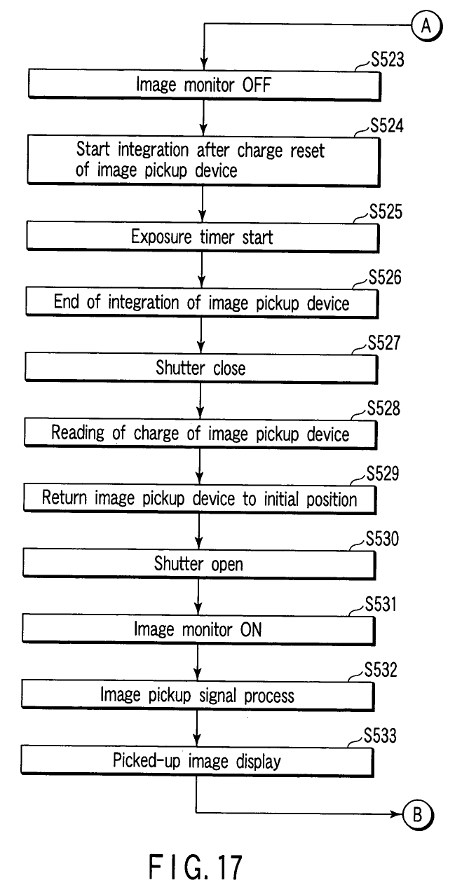

FIGS. 16 and 17 are flowcharts showing control procedure of exposure process in the third embodiment. The camera control unit 5 determines the present camera shake correction mode (step S501).

In step S501, if the camera shake correction mode is the correction ON mode, the camera control unit 5 turns on the camera shake detecting unit 1 by way of the camera shake correction control unit 2 (step S502). Subsequently, by camera shake calculation (step S503), the image pickup device 6 is driven according to the result of calculation (step S504). The camera control unit 5 moves up the movable mirror 12 (step S505), resets the electric charge accumulated in the image pickup device 6, and starts integration operation (step S506).

Further, the camera control unit 5 opens the shutter 10 (step S507). Then, a timer (not shown) for measuring the exposure time is started (step S508). After exposure time, the camera control unit 5 terminates the integration operation of the image pickup device 6 (step S509), and closes the shutter 10 (step S510). Thereafter, the electric charge accumulated in the image pickup device 6 is read out (step S512), and the movable mirror 12 is moved down (step S513). The camera control unit 5 turns off the camera shake detecting unit 1, and returns the positions of the image pickup device 6 to the initial position (step S514), and then the process goes out of the flowchart.

In step S501, when the camera shake correction mode is the correction OFF, the camera control unit 5 moves up the movable mirror 12 (step S515), resets the electric charge accumulated in the image pickup device 6, and starts integration operation (step S516).

Consequently, the camera control unit 5 opens the shutter 10 (step S517). Then, the timer (not shown) for measuring the exposure time is started (step S518). After exposure time, the camera control unit 5 terminates the integration operation of the image pickup device 6 (step S519), and closes the shutter 10 (step S520). Thereafter, the electric charge accumulated in the image pickup device 6 is read out (step S521), and the movable mirror 12 is moved down (step S522). Then, the process goes out of the flowchart.

In step S501, when the camera shake correction mode is the correction ON (DEMO) mode, the camera control unit 5 turns off the image monitor 8 (step S523). The camera control unit 5 resets the electric charge accumulated in the image pickup device 6, and starts integration operation (step S524).

Consequently, the timer (not shown) for measuring the exposure time is started (step S525). After exposure time, the camera control unit 5 terminates the integration operation of the image pickup device 6 (step S526), and closes the shutter 10 (step S527). Then, the electric charge accumulated in the image pickup device 6 is read out (step S528), and the position of the image pickup device 6 is returned to the initial position (step S529). Then the camera control unit 5 opens the shutter (step S530).

After the camera control unit 5 turns on the image monitor 8 (step S531), the image of the output of the image pickup device 6 is processed in the image pickup signal processing unit 7 (step S532), and the result is displayed on the image monitor 8 (step S533). Then, the process goes out of the flowchart.

The invention has been described specifically herein by referring to the embodiments, but the invention is not limited to the illustrated embodiments alone, but may be changed and modified within the scope of the invention.

For example, in the embodiments, the technology of the invention is applied to the digital camera, but the technology of the invention may be also applied to other complicated products having the camera function, such as a portable phone with camera function, a personal digital assistant with camera function, and a portable computer with camera.

Further, various modes explained in the embodiments may be freely combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A camera comprising:
an image pickup device which outputs image data by receiving incident luminous flux from an imaging optical system that receives luminous flux from a subject to be imaged;
an image monitor which displays an image on the basis of the image data outputted from the image pickup device;
an optical finder to observe the subject to be imaged;
a movable mirror disposed in an optical path between the imaging optical system and the image pickup device, the movable mirror guiding the luminous flux incoming from the imaging optical system to an optical finder side when observing the subject through the optical finder, and guiding the luminous flux incoming from the imaging optical system to an image pickup device side by moving away from the optical path when taking a photograph;
a camera shake correction unit which corrects camera shake by moving the image pickup device in a direction cross to the imaging optical axis of the imaging optical system;
a camera shake correction mode setting unit which sets the imaging mode of the camera in a camera shake correction mode of taking a photograph by operating the camera shake correction unit; and
an operation control unit which moves the movable mirror away from the optical path when the imaging mode is set in the camera shake correction mode by the camera shake correction mode setting unit, causes the image pickup device to output image data repeatedly, and displays the image on the image monitor on the basis of the repeatedly outputted image data.

2. The camera according to claim 1, wherein, when the camera shake correction mode is canceled, the operation control unit controls to return the movable mirror to the optical path and stop image display on the image monitor.

3. The camera according to claim 1, wherein, when the camera is not handled continuously for a predetermined time after operation of the camera shake correction unit, the operation control unit controls to return the movable mirror to the optical path and stop image display on the image monitor, and then set an operation mode of the camera in a power saving mode.

4. The camera according to claim 3, wherein, when the power saving mode is canceled, in the case where the imaging mode of the camera is set in the camera shake correction mode by the camera shake correction mode setting unit, the operation control unit controls to move the movable mirror away from the optical path, cause the image pickup device to output image data repeatedly, and display the image on the image monitor on the basis of the repeatedly outputted image data.

5. The camera according to claim 1, wherein the optical finder has a notice unit which notifies depending on the status of setting by the camera shake correction mode setting unit, and
the operation control unit controls to cause the notice unit to notify setting of the camera shake correction mode when the imaging mode of the camera is set in the camera shake correction mode by the camera shake correction mode setting unit.

6. The camera according to claim 5, further comprising a camera shake detecting unit which detects the magnitude of camera shake occurring in the camera,
wherein the notice unit further notifies the degree of camera shake depending on the magnitude of camera shake detected by the camera shake detecting unit.

7. A camera comprising:
an image pickup device which outputs image data by receiving incident luminous flux from an imaging optical system that receives luminous flux from a subject to be imaged;
a camera shake correction unit which corrects camera shake by moving the image pickup device in a direction cross to the imaging optical axis of the imaging optical system;
an image monitor comprising a first display mode for displaying an image on the basis of the image data outputted from the image pickup device when the camera shake correction unit is in action, and a second display mode for displaying an image on the basis of the image data outputted from the image pickup device when the camera shake correction unit is not in action;
a camera shake correction mode setting unit which sets the imaging mode of the camera in a camera shake correction mode of taking a photograph by operating the camera shake correction unit; and
an operation control unit which controls to change over the display modes of the image monitor depending on the setting state of the camera shake correction mode setting unit.

8. A camera comprising:
an image pickup device which outputs image data by receiving incident luminous flux from an imaging optical system that receives luminous flux from a subject to be imaged;
an image monitor which displays an image on the basis of the image data outputted from the image pickup device;
an optical finder to observe the subject to be imaged;
a movable mirror disposed in an optical path between the imaging optical system and the image pickup device, the movable mirror guiding the luminous flux incoming from the imaging optical system to an optical finder side when observing the subject through the optical finder, and guiding the luminous flux incoming from the imaging optical system to an image pickup device side by moving away from the optical path when taking a photograph;
a camera shake correction unit which corrects camera shake by moving the image pickup device in a direction cross to the imaging optical axis of the imaging optical system;
a camera shake correction mode setting unit which sets the imaging mode of the camera in a camera shake correction mode of taking a photograph by operating the camera shake correction unit; and
an operation control unit which operates by changing over between a first observation mode and a second observation mode, the first observation mode enabling observation of the subject through the optical finder by disposing the movable mirror on the optical path when the imaging mode is set in the camera shake correction mode by the camera shake correction mode setting unit, and the second observation mode enabling observation of the subject by displaying the image data from the image pickup device on the image monitor by moving the movable mirror away from the optical path when the imaging mode is set in the camera shake correction mode by the camera shake correction mode setting unit.

9. A camera comprising:
an image pickup device which outputs image data by receiving incident luminous flux from an imaging optical system that receives luminous flux from a subject to be imaged;
an image monitor which displays an image on the basis of the image data outputted from the image pickup device;
an optical finder to observe the subject to be imaged;
a movable mirror disposed in an optical path between the imaging optical system and the image pickup device, the movable mirror guiding the luminous flux incoming from the imaging optical system to an optical finder side when observing the subject through the optical finder, and guiding the luminous flux incoming from the imaging optical system to an image pickup device side by moving away from the optical path when taking a photograph;
a camera shake correction unit which corrects camera shake by moving the image pickup device in a direction cross to the imaging optical axis of the imaging optical system;
a camera shake correction mode setting unit which sets the imaging mode of the camera in a camera shake correction mode of taking a photograph by operating the camera shake correction unit; and
an operation control unit which can move the movable mirror away from the optical path when the imaging mode is set in the camera shake correction mode by the camera shake correction mode setting unit, causes the image pickup device to output image data repeatedly, and displays the image on the image monitor on the basis of the repeatedly outputted image data.

10. A camera comprising:
an image pickup device which outputs image data by receiving incident luminous flux from an imaging optical system that receives luminous flux from a subject to be imaged;
an image monitor which displays an image on the basis of the image data outputted from the image pickup device;
an optical finder to observe the subject to be imaged;
a movable mirror disposed in an optical path between the imaging optical system and the image pickup device, the movable mirror guiding the luminous flux incoming from the imaging optical system to an optical finder side when observing the subject through the optical finder, and guiding the luminous flux incoming from the imaging optical system to an image pickup device side by moving away from the optical path when taking a photograph;
a camera shake correction unit which corrects camera shake by moving the image pickup device in a direction cross to the imaging optical axis of the imaging optical system;
a camera shake correction mode setting unit which sets the imaging mode of the camera in a camera shake correction mode of taking a photograph by operating the camera shake correction unit; and
an operation control unit which controls by moving the movable mirror away from the optical path when the imaging mode is set in the camera shake correction mode by the camera shake correction mode setting unit, causes the image pickup device to output image data repeatedly, and displays the image on the image monitor on the basis of the repeatedly outputted image data, or controls by disposing the movable mirror on the optical path to allow to observe the subject through the optical finder when the imaging mode is set in a non-camera shake correction mode by the camera shake correction mode setting unit.

11. A camera comprising:
imaging means for outputting image data by receiving incident luminous flux from an imaging optical system that receives luminous flux from a subject to be imaged;
display means for displaying an image on the basis of the image data outputted from the imaging means;
finder means for observing the subject to be imaged;
mirror means disposed in an optical path between the imaging optical system and the imaging means, for guiding the luminous flux incoming from the imaging optical system to a finder means side when observing the subject through the finder means, the mirror means moving away from the optical path when taking a photograph to guide the luminous flux incoming from the imaging optical system to an imaging means side;
camera shake correction means for correcting camera shake by moving the imaging means in a direction cross to the imaging optical axis of the imaging optical system;
camera shake correction mode setting means for setting the imaging mode of the camera in a camera shake correction mode of taking a photograph by operating the camera shake correction means; and
operation control means for moving the mirror means away from the optical path when the imaging mode is set in the camera shake correction mode by the camera shake correction mode setting means, causing the imaging means to output image data repeatedly, and controlling to display the image on the display means on the basis of the repeatedly outputted image data.

12. A camera comprising:
image pickup means for outputting image data by receiving incident luminous flux from an imaging optical system that receives luminous flux from a subject to be imaged;
display means for displaying an image on the basis of the image data outputted from the image pickup means;
finder means for observing the subject to be imaged;
mirror means disposed in an optical path between the imaging optical system and the image pickup means, for guiding the luminous flux incoming from the imaging optical system to a finder means side when observing the subject through the finder means, and guiding the luminous flux incoming from the imaging optical system to an image pickup means side by moving away from the optical path when taking a photograph;
camera shake correction means for correcting camera shake by moving the image pickup means in a direction cross to the imaging optical axis of the imaging optical system;
camera shake correction mode setting means for setting the imaging mode of the camera in a camera shake correction mode of taking a photograph by operating the camera shake correction means; and
operation control means for operating by changing over between a first observation mode and a second observation mode, the first observation mode enabling observation of the subject through the finder means by disposing the mirror means on the optical path when the imaging mode is set in the camera shake correction mode by the camera shake correction mode setting means, and the second observation mode enabling observation of the subject by displaying the image data from the image pickup means on the display means by moving the mirror means away from the optical path when the imaging mode is set in the camera shake correction mode by the camera shake correction mode setting means.

13. A camera comprising:
imaging means for outputting image data by receiving incident luminous flux from an imaging optical system that receives luminous flux from a subject to be imaged;
display means for displaying an image on the basis of the image data outputted from the imaging means;
finder means for observing the subject to be imaged;
mirror means disposed in an optical path between the imaging optical system and the imaging means, for guiding the luminous flux incoming from the imaging optical system to a finder means side when observing the subject through the finder means, the mirror means moving away from the optical path when taking a photograph to guide the luminous flux incoming from the imaging optical system to an imaging means side;
camera shake correction means for correcting camera shake by moving the imaging means in a direction cross to the imaging optical axis of the imaging optical system;
camera shake correction mode setting means for setting the imaging mode of the camera in a camera shake correction mode of taking a photograph by operating the camera shake correction means; and
an operation control means for being able to move the mirror means away from the optical path when the imaging mode is set in the camera shake correction mode by the camera shake correction mode setting means, to cause the image pickup means to output image data repeatedly, and to display the image on the display means on the basis of the repeatedly outputted image data.

14. A subject observing method using a camera comprising: an image pickup device which outputs image data by receiving incident luminous flux from an imaging optical system that receives luminous flux from a subject to be imaged; an image monitor which displays an image on the basis of the image data outputted from the image pickup device; an optical finder which observes the subject to be imaged; a movable mirror disposed in an optical path between the imaging optical system and the image pickup device, the movable mirror guiding the luminous flux incoming from the imaging optical system to an optical finder side when observing the subject through the optical finder, and guiding the luminous flux incoming from the imaging optical system to an image pickup device side by moving away from the optical path when taking a photograph; a camera shake correction unit which corrects camera shake by moving the image pickup device in a direction cross to the imaging optical axis of the imaging optical system; and a camera shake correction mode setting unit which sets the imaging mode of the camera in a camera shake correction mode of taking a photograph by operating the camera shake correction unit, the method comprising:
controlling by moving the movable mirror away from the optical path when the imaging mode is set in the camera shake correction mode by the camera shake correction mode setting unit, causing the image pickup device to output image data repeatedly, and displaying the image on the image monitor on the basis of the repeatedly outputted image data.
